(19) United States
(12) Patent Application Publication
(10) Pub. No.: US 2005/0215684 A1
(43) Pub. Date: Sep. 29, 2005

(54) Pneumatic tire with built-in black colored sealant with viscoelastic modulus property

(75) Inventor: Jennifer Elizabeth Fitzharris Wall, Massillon, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: The Goodyear Tire & Rubber Company

(21) Appl. No.: 11/126,503

(22) Filed: May 11, 2005

Related U.S. Application Data
(63) Continuation-in-part of application No. 10/917,620, filed on Aug. 13, 2004.
(60) Provisional application No. 60/524,217, filed on Nov. 21, 2003.

(51) Int. Cl. C08K 3/26; C08K 3/04; C08K 3/34

(52) U.S. Cl. 524/425; 524/492; 524/495

(57) ABSTRACT

The present invention relates to a pneumatic tire with a built-in depolymerized butyl rubber sealant layer having a black color of a composition which has a low strain storage modulus (G′) dynamic viscoelastic property (100° C., 5 percent dynamic strain and 1 hertz) in a range of from about 1 to about 100 kPa, alternately in a range of from about 10 to about 65 kPa. The sealant layer is derived from a sealant precursor layer comprised of a butyl rubber, organoperoxide and filler comprised of carbon black and silica wherein the sealant contains a sufficient amount of carbon black to color it black. The butyl rubber-based precursor sealant layer is built into the tire to form a tire assembly and its butyl rubber component is depolymerized during a subsequent curing of the tire at an elevated temperature in a suitable mold to form the tire having the resultant built-in black colored sealant layer. The sealant precursor composition may additionally contain clay and/or calcium carbonate.

### FIELD OF THE INVENTION

The present invention relates to a pneumatic tire with a built-in depolymerized butyl rubber sealant layer having a black color of a composition which has a low strain storage modulus (G′) dynamic viscoelastic property (100° C., 5 percent dynamic strain and 1 hertz) in a range of from about 1 to about 100 kPa, alternately in a range of from about 10 to about 65 kPa. The sealant layer is derived from a sealant precursor layer comprised of a butyl rubber, organoperoxide and filler comprised of carbon black and silica wherein the sealant contains a sufficient amount of carbon black to color it black. The butyl rubber-based precursor sealant layer is built into the tire to form a tire assembly and its butyl rubber component is depolymerized during a subsequent curing of the tire at an elevated temperature in a suitable mold to form the tire having the resultant built-in black colored sealant layer. The sealant precursor composition may additionally contain clay and/or calcium carbonate.

### BACKGROUND OF THE INVENTION

Various pneumatic tires have been proposed which contain a built-in sealant layer based upon a depolymerized butyl rubber layer.

For example, in U.S. Pat. No. 4,895,610 it is proposed to build a layer of butyl rubber-based composition into a tire which contains a polyisobutylene polymer and an organoperoxide, following which under a conditions of elevated temperature used to cure the tire, a major portion of the butyl rubber is presented as being depolymerized to form a tacky material which has puncture sealant properties.

U.S. Pat. Nos. 4,228,839, 4,171,237 and 4,140,167 also relate to a sealant layer in a tire formed by depolymerizing and crosslinking a butyl rubber-based rubber composition, particularly by irradiation treatment.

U.S. Patent Application Publication No. 2003/0230376 A1, relates to a tire with built-in sealant comprised of a partially depolymerized butyl rubber via an organoperoxide which contains a dispersion of particulate pre-cured rubber particles.

U.S. patent application Ser. No. 10/368,259, filed Feb. 17, 2003, relates to a tire with built-in sealant comprised of a partially depolymerized butyl rubber via an organoperoxide which contains a particulate filler comprised of carbon black and/or coal dust and, optionally short fibers, hollow glass microspheres and rubber processing oil wherein the sealant may also contain a liquid diene-based polymer.

U.S. Patent Application Publication No. 2005/0034799 A1 relates to a self sealing tire containing a sealing material which may be contained within the tire and which may be comprised of a thermally degraded butyl rubber with an organic peroxide and containing a reinforcing filler.

Additional patent publications which relate to various tire constructions which may involve built-in or built-on sealants for tires such as for example, U.S. Pat. Nos. 1,239,291, 2,877,819, 3,048,509, 3,563,294, 4,206,796, 4,286,643, 4,359,078, 4,444,294, 4,895,610, 4,919,183 and 4,966,213.

In one aspect, the various built-in sealant layers for the pneumatic tires which are derived from a depolymerization of a butyl rubber-based sealant precursor composition typically contain a rubber reinforcing carbon black filler and are therefore black in color.

For this invention, it is desired to provide a built-in sealant layer for a pneumatic tire which is derived from a depolymerization of a butyl rubber-based sealant precursor composition which is of a black color. Therefore, in one aspect, it is envisioned that such a sealant layer contains a sufficient amount of carbon black and particularly a rubber reinforcing carbon black to color the sealant layer black.

The presence of the rubber reinforcing carbon black is considered herein to normally be a significant component in both a butyl rubber-based sealant precursor composition and, also, in the resultant depolymerized butyl rubber-based sealant composition.

In particular, the presence of a significant amount of the rubber reinforcing carbon black in the butyl rubber-based sealant precursor composition is relied upon to provide a degree of reinforcement and thereby a suitable rubber viscosity to enable the sealant precursor composition to be conveniently processable both by formation into a suitable rubber sheet whether by extrusion or calendering and, also, by handling to build a sheet, or layer, of the sealant precursor composition into a tire assembly. Further, the rubber reinforcing carbon black is relied upon to provide a suitable viscosity of the built-in sealant in order to promote the stability of the sealant composition.

However, for this invention, a significant amount of synthetic, amorphous silica (aggregates of primary silica particles), preferably in the form of a precipitated silica, is used as a reinforcing filler in combination with the carbon black for the butyl rubber-based sealant precursor composition.

In another aspect of the invention, a portion of the silica may be replaced by clay, for example kaolin clay, and/or calcium carbonate. In practice, therefore, the butyl rubber-based sealant precursor may contain clay and/or calcium carbonate in addition to the amorphous silica.

However, the clay and calcium carbonate are not considered herein as being as effective reinforcing ingredients for the butyl rubber based rubber composition as the aforesaid silica. Accordingly, only a partial replacement of the silica with the clay and/or calcium carbonate is contemplated.

Significant challenges are presented in the use of both carbon black and synthetic, amorphous silica, particularly precipitated silica as well as the clay and calcium carbonate.

For example, contrary to rubber reinforcing carbon black, such silica, particularly precipitated silica (precipitated silica aggregates of primary silica particles), normally contains a significant presence of water of hydration, and/or water of association on its surface as well as a significant presence of hydroxyl groups (e.g. silanol groups). The clay and calcium carbonate may also contain an associated water moiety.

While the mechanism may not be fully understood, it is envisioned that at least a portion of such water, and possibly a portion of such hydroxyl groups, is available to prematurely decompose the organoperoxide intended to be used to depolymerize the butyl rubber in the sealant precursor composition.

It is considered herein that such premature decomposition of the organoperoxide, whether by presence of the water of hydration and/or association or by the presence of the hydroxyl groups, may adversely affect the free radical generating activity of the organoperoxide for a timely depolymerization of the butyl rubber after the sealant precursor layer is built into the tire assembly and the tire is cured at an elevated temperature. Such prematurely formed free radicals may become associated with the silica, and possibly the clay and calcium carbonate, rather than be involved with the desired depolymerization of the butyl rubber. It is further envisioned that if excess organoperoxide is added to allow for such premature decomposition, a portion of such excess organoperoxide may later or otherwise gradually become available to interact with associated rubber layers of the tire assembly, or construction, adjacent to the built-in sealant.

In order to inhibit, retard and/or significantly prevent significant contact of such water moieties and hydroxyl groups of the amorphous silica aggregates with the organoperoxide, the synthetic amorphous silica may be treated in situ within the rubber composition prior to addition of the organoperoxide, or may be pre-treated prior to its addition to the rubber composition with a low molecular weight polyalkylene oxide polymer, which might sometimes be referred to as a polyalkylene glycol; with an alkylsilane, a coupling agent having a moiety reactive with the hydroxyl groups on the silica and another moiety which is normally interactive with carbon-to-carbon double bonds of an elastomer or by a combination of alkylsilane and coupling agent.

In another aspect of the practice of the invention, while the butyl rubber, as a copolymer of isobutylene and isoprene, may be composed of greater than one weight percent units derived from isoprene, it is preferred that it is composed of from only about 0.5 to about 1.0 weight percent units derived from isoprene. The use of a butyl rubber with such low unsaturation is to promote a more efficient depolymerization by treatment with the organoperoxide where it is envisioned that the presence of the double bonds within the butyl rubber terminates its depolymerization when the depolymerization process reaches the double bond unsaturation in the butyl rubber.

In a further aspect of the invention, to promote better processing of the butyl rubber-based sealant precursor composition, it is desired to use a butyl rubber that has a relatively high Mooney viscosity (ML+8) value at 125° C. in a range of from about 25 to about 60, alternately from about 40 to about 60.

Alternatively, a plurality of butyl rubbers (e.g. a combination of two butyl rubbers) may be used comprised of, for example, a first butyl rubber having a Mooney (ML1+4), 125° C., viscosity in a range of from about 35 to about 60 and at least one additional, or second, butyl rubber having a Mooney (ML1+4), 125° C., in a range of from about 25 to about 45, wherein the Mooney viscosity of said first butyl rubber is at least 10 Mooney viscosity units higher than the Mooney viscosity of said additional, or second, butyl rubber.

Thus the presence of a butyl rubber of very low isoprene-based unsaturation (for more effective depolymerization of the butyl rubber) and relatively high Mooney viscosity (to promote better physical handling of the sealant precursor composition) is desired.

In practice, it is desired herein for the butyl rubber-based sealant precursor composition to have a storage modulus (G′) physical property, at a 5 percent dynamic strain at 100° C. and 1 hertz in a range of about 170 to about 350 kPa, alternately in a range of from about 225 to about 300 kPa.

For such purpose, it is desired herein for the depolymerized butyl rubber sealant composition to have a significant lower storage modulus (G′) physical property, at a 5 percent dynamic strain at 100° C. and 1 hertz in a range of from about 1 to about 100 kPa, alternately from about 10 to about 100 kPa, and further alternately in a range of from about 10 to about 65 kPa.

An important aspect of this invention is providing a pneumatic tire with a built-in black colored sealant layer positioned (sandwiched) between dimensionally stable sulfur vulcanized rubber layers (e.g. between a tire inner liner rubber layer and tire carcass) which promotes sealing against an externally puncturing object to prevent, or significantly retard, leakage of gas (e.g. air) from the tire cavity through the puncture to the outside of the tire by allowing the pressure within the tire cavity (e.g. air pressure greater than ambient atmospheric pressure) to press the black colored sealant against the puncturing object or the cavity caused by the puncturing object.

The air sealing quality of the built-in sealant layer relies upon a combination of its aforesaid storage modulus (G′) physical property and pressure differential between the inner surface of the tire cavity (e.g. air pressure within the tire cavity) and atmospheric pressure outside of the tire to cause the built-in sealant layer to seal against the puncturing object and/or the puncture itself to prevent leakage of air from the tire cavity to the atmosphere.

Accordingly, a tire is provided wherein the said silica and carbon black containing built-in sealant layer with its said storage modulus (G′) characterization is designed to seal against a puncturing object which extends through the tire casing to said built-in sealant layer, and/or a puncture extending through the tire casing to said built-in sealant layer caused by said puncturing object, by the said sealant layer actively physically pressing against said puncturing object and/or said puncture as a response to a pressure differential between the air contained in the tire cavity and external atmospheric pressure to seal against said puncturing object or said puncture preferably without relying solely upon a simple gravity flow of the said sealant layer, in the absence of said pressure differential.

This is considered herein to be significant departure from, and in significant contrast to, more fluid sealants (e.g. liquid sealants or even built-in sealants with lower storage modulus (G′) characteristic physical property) which tend to rely upon their own relatively low viscosity to cause the sealant to seal against the puncturing object and/or puncture itself.

In practice, various physical properties of the black colored sealant are difficult to measure with most laboratory equipment (which are typically used to analyze solid blocks of rubber) because of its inherent tendency to flow into a crevice or against a puncturing object under the aforesaid internal tire air pressure.

However, the storage modulus (G′) of the black colored sealant rubber composition can be suitably measured by appropriate laboratory equipment (e.g. an RPA, or Rubber Process Analyzer instrument which can measure a strain sweep at 100° C. and 1 hertz over a range of from 1 to 50 percent strain) because such equipment does not require a sample as a solid block of rubber but can analyze a rubber sample positioned between layers of plastic film (e.g. mylar film).

Accordingly, a significant aspect of the invention is the use of a black colored sealant composition of this invention, which contains reinforcing filler as a combination of carbon black and silica, preferably precipitated silica, which has a storage modulus G′ (100° C., 1 hertz at 5 percent strain) in a range of from about 1 to about 100 MPa or more preferably an a narrower range of from about 10 to about 100 MPa and more preferably in a range of from about 65 about 100 MPa in order to provide the aforesaid puncture sealing objectives.

The aforesaid storage modulus G′ property of the sealant of this invention is the result of a complex network which includes a balance of a combination of the degree of organoperoxide depolymerization of its butyl rubber component, the inclusion of the treated precipitated silica, carbon black and the use of a butyl rubber with a relatively low carbon-to-carbon unsaturation content for the sealant precursor, as well as a balance of one or more of optionally included calcium carbonate, clay and other inert fillers if used. It is to be readily appreciated that such storage modulus G′ property is not applicable to and cannot be suitably measured on liquid sealants based upon water/glycol mixtures because such products do not contain an effective viscoelastic component with the aforesaid resultant complex network of the built-in sealant layer of this invention.

In practice, such storage modulus (G′) for the built-in sealant may be determined, for example, by an RPA (Rubber Process Analyzer) instrument which measures the strain sweep at 100° C. at 1 Hertz over a range of, for example, from 1 to 50 percent strain. Such storage modulus (G′) measurement for rubber samples is well known to those having skill in such art. Such a Rubber Process Analyzer is RPA 2000™ instrument by Alpha Technologies, formerly the Flexsys Company and formerly the Monsanto Company.

References to an RPA-2000 instrument may be found in the following publications: H. A. Palowski, et al, Rubber World, June 1992 and January 1997, as well as Rubber &Plastics News, Apr. 26 and May 10, 1993.

In the description of this invention, the term “phr” is used to designate parts by weight of an ingredient per 100 parts of elastomer unless otherwise indicated. The terms “elastomer” and “rubber” are used interchangeably unless otherwise indicated. The terms “cure” and “vulcanize” are used interchangeably unless otherwise indicated.

### SUMMARY AND PRACTICE OF THE INVENTION

In accordance with this invention, a (carbon black reinforced) pneumatic rubber tire having a built-in black colored puncture sealing layer is provided;
wherein said puncture sealing layer contains an at least partially organoperoxide-depolymerized butyl rubber-based sealant layer, (normally positioned between a carbon black reinforced halobutyl rubber-based tire innerliner layer and tire carcass, or between two tire innerliner rubber layers, and therefore covered by at least one tire innerliner rubber layer), wherein said puncture sealing layer is comprised of, based upon parts by weight per 100 parts by weight of said partially depolymerized butyl rubber,
wherein, however, and provided that said puncture sealing layer has a low strain storage modulus (G′) dynamic viscoelastic property (100° C., 5 percent dynamic strain and 1 hertz) in a range of from about 1 to about 100 kPa, alternately from about 10 to about 100 kPa:
(A) a partially organoperoxide-depolymerized butyl rubber as a copolymer of isobutylene and isoprene,
wherein said butyl rubber, prior to such depolymerization, is comprised of about 0.5 to about 5, preferably within a range of from 0.5 to one, percent units derived from isoprene, and correspondingly from about 95 to about 99.5, preferably within a range of from 99 to 99.5, weight percent units derived from isobutylene;
(B) about 24 to about 100, alternately about 26 to about 100, phr of particulate reinforcing filler comprised from 4 to about 50, alternately from about 6 to about 50, phr of carbon black, preferably rubber reinforcing carbon black, so long as the carbon black content of said puncture sealing layer is sufficient to color the said puncture sealing layer black, and:
   (1) about 20 to about 50 phr of synthetic amorphous silica, preferably precipitated silica, or
   (2) about 15 to about 30 phr synthetic amorphous silica, preferably precipitated silica, and about 5 to about 20 phr of clay, preferably kaolin clay, or
   (3) about 15 to about 30 phr synthetic amorphous silica, preferably precipitated silica, and about 5 to about 20 phr of calcium carbonate, or
   (4) about 15 to about 30 phr synthetic amorphous silica, preferably precipitated silica, about 5 to about 15 phr of clay, preferably kaolin clay, and about 5 to about 15 phr of calcium carbonate;
(C) from zero to 6, alternately about 0.5 to about 5, phr of short organic fibers;
(D) from zero to about 20, alternately about 2 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent;
wherein said synthetic amorphous silica (preferably precipitated silica), and clay and calcium carbonate where used, is treated by treatment prior to addition of said organoperoxide either in situ within the rubber composition or by pre-treatment of said silica prior to its addition to the rubber composition to inhibit adsorption or absorption of the said organoperoxide on the surface of said silica, for example, by treatment of said silica, with:
(A) a polyethylene glycol having a weight average molecular weight in a range of from about 2,000 to about 15,000, alternately about 2,000 to about 10,000, or
(B) an alkoxysilane or
(C) a coupling agent selected from a bis(3-trialkoxysilylalkyl) polysulfide or organomercaptoalkoxysilane, or
(D) a combination of alkylsilane, particularly an alkoxysilane, and bis(3-trialkoxysilylalkyl) polysulfide or organomercaptoalkoxysilane.

Alternately, said particulate synthetic amorphous silica reinforcing filler may be comprised of:
(A) about 20 to about 50 phr of synthetic amorphous silica having a BET surface area in a range of from about 50 to about 70 M²/g, or
(B) about 12 to about 30 phr of synthetic amorphous silica having a BET surface area in a range of from about 110 to about 200 m²/g, or
(C) about 15 to about 30 phr synthetic amorphous silica having a BET surface area in a range of from about 50 to about 70 m²/g and about 5 to about 20 phr of clay, or
(D) about 5 to about 25 phr synthetic amorphous silica having a BET surface area in a range of from about 110 to about 200 m²/g and about 5 to about 20 phr of clay, or
(E) about 15 to about 30 phr synthetic amorphous silica having a BET surface area in a range of from about 50 to about 70 m²/g and about 5 to about 20 phr of calcium carbonate, or
(F) about 5 to about 25 phr synthetic amorphous silica having a BET surface area in a range of from about 110 to about 200 m²/g and about 5 to about 20 phr of calcium carbonate, or
(G) about 15 to about 30 phr synthetic amorphous silica having a BET surface area in a range of from about 50 to about 70 m²/g, about 5 to about 15 phr of clay and about 5 to about 15 phr of calcium carbonate, or
(H) about 5 to about 25 phr synthetic amorphous silica having a BET surface area in a range of from about 110 to about 200 m²/g, about 5 to about 15 phr of clay and about 5 to about 15 phr of calcium carbonate.

Therefore, in practice, said black colored sealant layer is positioned between a carbon black reinforced innerliner and tire carcass, or between two carbon black reinforced tire innerliners, and wherein said tire has a carbon black reinforced tread and sidewall.

A significant aspect of the invention is the use of the black colored build-in sealant which contains a combination of both a significant amount of carbon black and a treated silica.

In practice, as hereinbefore discussed, said synthetic amorphous silica may be a precipitated silica treated by treatment prior to addition of said organoperoxide either in situ within the rubber composition or by pre-treatment of the silica prior to its addition to the rubber composition with:
(A) a polyethylene glycol having a weight average molecular weight in a range of from about 2,000 to about 15,000, alternately about 2,000 to about 10,000, or
(B) an alkoxysilane or
(C) a coupling agent selected from a bis(3-trialkoxysilylalkyl) polysulfide or organomercaptoalkoxysilane, or
(D) a combination of alkylsilane, particularly an alkoxysilane, and bis(3-trialkoxysilylalkyl) polysulfide or organomercaptoalkoxysilane.

Accordingly, in one aspect of the invention, said synthetic amorphous silica may be a composite of precipitated silica and
(A) said polyethylene glycol, or
(B) alkoxysilane, or
(C) a coupling agent selected from a bis(3-trialkoxysilylalkyl) polysulfide or organomercaptoalkoxysilane, or
(D) a combination of alkylsilane, particularly an alkoxysilane, and bis(3-trialkoxysilylalkyl) polysulfide or organomercaptoalkoxysilane.

Representative examples of polyethylene glycols are polyethylene glycols having an average (weight average) molecular weight in a range of from about 2,000 to about 15,000, alternately from about 2,000 to about 10,000, are preferred.

Examples of commercially available polyethylene glycols may be, for example, those such as Carbowax™ PEG 3350 as well as Carbowax™ PEG 8000 from the Dow Chemical Company with said Carbowax™ PEG 8000 reportedly having a weight average molecular weight in a range of about 7,000 to about 9,000 as determined by its NIR (near infrared) method 1B-ZMETH1.3. A further discussion concerning various polyalkylene oxide polymers, and particularly polyethylene glycols including said Carbowax PEG 8000 may be found, for example, although not intended to be limitive, in U.S. Pat. Nos. 6,322,811 and 4,082,703.

Said bis(3-trialkoxysilylalkyl) polysulfide, preferably a bis(3-triethoxysilylpropyl) polysulfide, contains an average of from 2 to about 4, preferably an average of from about 2 to about 2.6 or an average of from about 3.5 to about 4, connecting sulfur atoms in its polysulfidic bridge;
Said alkoxysilane may be of the general formula (I):
   (RO)₃—Si—R¹ (I)
where R is selected from methyl and ethyl radicals, preferably ethyl radicals, and R¹ is a saturated alkyl radical having from 2 through 6 carbon atoms.

Representative of said alkoxysilanes are, for example, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

Said organomercaptoalkoxysilane may be of the general formula (II):
(X)ₙ(R²O)₃₋ₙ—Si—R³—SH (II)
wherein X is a radical selected from chlorine, bromine, and alkyl radicals having from one to 16 carbon atoms; wherein R² is an alkyl radical selected from methylene and ethylene radicals, R³ is an alkylene radical having from one to 16 carbon atoms and n is a value from zero to 3.

Representative of alkoxyorganomercaptosilanes, particularly for pre-treatment of the silica prior to its addition to the rubber composition are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

In practice, various clays may be used. Representative of such clays are, for example, kaolin clays. It is envisioned herein that a benefit of utilization of such clay is to provide a modified, or tempered, degree of reinforcement, as compared to the silica, for the sealant precursor composition to aid in its aforesaid processing and also to aid, in combination with the silica, in providing the aforesaid resultant storage modulus (G′) of the resultant depolymerized butyl rubber-based sealant composition.

In practice, the calcium carbonate may also be used. As with the aforesaid clay, it is envisioned that a benefit of utilization of such calcium carbonate is to provide a modified, or tempered, degree of reinforcement, as compared to the silica, for the sealant precursor composition to aid in its aforesaid processing and also to aid, in combination with the silica, in providing the aforesaid resultant storage modulus (G′) of the resultant depolymerized butyl rubber-based sealant composition.

For this invention, various synthetic amorphous silicas may be used, such as, and preferably, precipitated silica. Representative of such precipitated silicas are, for example and not intended herein to be limitative, HiSil 532™ from PPG Industries, Hubersil 4155™ from the J. M. Huber Company and Ultrasil™ VN2 and VN3 from the Degussa Company.

Such precipitated silicas are silica aggregates which are considered herein to be in an agglomerated (compacted) form with relatively very low BET (nitrogen) surfaces areas (e.g. reportedly about 60 m²/g for the HiSil 532™ and Hubersil 4155™ silica aggregates, provided in an agglomerated form).

A method of measuring BET (nitrogen) surface area of precipitated silicas is ASTM D 1993-91, Standard Test Method for Precipitated Silica-Surface Area by Multipoint BET Nitrogen Adsorption which relates to the conventional theory described by Brunauer, Emmett and Teller in the Journal of the American Chemical Society, Volume 60, (1938), Page 309.

Accordingly, in one aspect of the invention, is considered herein an optimal BET surface area of the precipitated silica may be, for example, in a range of from about 50 to about 70 m²/g, thus indicating a precipitated silica of a relatively large particle size.

However, in a further aspect of the invention, a precipitated silica having a considerably greater BET surface area (indicative of a significantly smaller particle size) might be used, if desired, such as, for example, a BET surface area in a range of from about 110 to about 200 m²/g, although it is believed that the green strength of the sealant precursor will be significantly reduced with an associated increase in processing and handling difficulty. Representative of such precipitated silicas are, for example, HiSil 210™ and HiSil315L™ from PPG Industries with reported BET values of about 135 and 125 m²/g, respectively. Although such precipitated silicas are not preferred silicas for use in this invention, if such smaller silicas are used, then the silica threshold in the sealant precursor and sealant composition is considered herein to be able to be reduced to a lower value to result in a range of the precipitated silica to be from about 12 to about 30 phr, of from about 5 to about 25 phr when used in combination with the clay and/or calcium carbonate.

The optional various rubber processing oils are well known to those having skill in such art. For this invention, a rubber processing oil having a low aromaticity content is preferred, namely a rubber processing oil having an aromaticity content of less than about 15 weight percent. Such a preferred rubber processing oil may be composed of, for example, about 35 to about 45 weight percent naphthenic content, about 45 to about 55 weight percent paraffinic content and an aromatic content of less than about 15 weight percent (e.g. from about 10 to about 14 weight percent). It is considered herein that a representative of such preferred rubber processing oil is Tufflo 100™ from the Barton Solvent Company. The rubber processing oil, in relatively low concentrations, is seen herein to aid in mixing the ingredients for the sealant precursor composition and to aid in promoting the aforesaid processing of sealant precursor composition.

The optional short fibers may be selected from, for example, cotton fibers and from synthetic fibers selected from rayon, aramid, nylon and polyester fibers, and their mixtures. In practice, such cotton short fibers may have an average length, for example, in a range of up to about 200 microns (e.g. an average length of about 150 microns) and the synthetic (e.g. the polyester and nylon fibers) may have an average length, for example, of up to a maximum of about 2,500 microns. The short fibers are considered herein to aid in promoting the effectiveness of the sealing ability of the resultant sealant composition. In relatively low concentrations, such synthetic fibers are not seen herein as significantly interfering with the processing of the sealant precursor composition yet as promoting the effectiveness of the resultant built-in sealant layer for its puncture sealing ability.

Various organoperoxides may be used for the sealant precursor butyl rubber-based composition. Preferably organoperoxides are used which become active (e.g. generate peroxide free radicals) at high temperatures, that is, for example, above about 100° C. Such organoperoxides are referred to therein as active peroxides. Examples of such organoperoxides which are considered herein as being active organoperoxides are, for example, tertbutyl perbenzoate and dialkyl peroxides with the same or different radicals, such as dialkylbenzene peroxides and alkyl pre-esters. Preferably the active organoperoxide will contain two peroxide groups. Frequently the peroxide groups are attached to a tertiary butyl group. The basic moiety on which the two peroxide groups are suspended can be aliphatic, cycloaliphatic, or aromatic radicals. Some representative examples of such active organoperoxides are, for example, n-butyl 4,4-di-(tert-butylperoxy) valerate, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy) hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy) hexane. The n-butyl 4,4-di-(tert-butylperoxy) valerate may be a preferred organoperoxide for use in the depolymerizing of the butyl rubber of the butyl rubber containing sealant precursor.

Such organoperoxide may be provided on a mineral carrier such as, for example calcium carbonate or a combination of calcium carbonate and calcium silicate. For example, the n-butyl 4,4-di-(tert-butylperoxy) valerate may be provided as a composite with a mineral carrier. Such mineral carrier may be, for example, combination of calcium carbonate and calcium silicate such as, for example, as Trigonox 17-40B-pd™ from the Akzo Nobel Polymer Chemicals LLC Company.

Thus, such active organoperoxides may be added to the sealant precursor butyl rubber-based composition layer usually as a composite with an inert, free-flowing mineral carrier, such as, for example, calcium carbonate. The organoperoxide as a composite thereof with a mineral carrier, such as for example calcium carbonate, is preferred for storing the peroxide and handling and processing. Such composite may be composed of, for example, from about 35 to 60 weight percent of the active organoperoxide.

In practice, a pneumatic tire having a puncture sealing ability comprised of an assembly of components comprised of an outer circumferential (sulfur curable) rubber tread, (sulfur curable) rubber carcass supporting said tread and an inner (sulfur curable) halobutyl rubber-based tire innerliner layer, may be prepared by, for example:
(A) positioning a layer of an uncured butyl rubber-based rubber composition, exclusive of sulfur curative, as a sealant layer precursor between said innerliner and rubber carcass barrier layer, wherein said sealant precursor butyl rubber-based composition is prepared by blending, based upon parts by weight per 100 parts of butyl rubber (phr):
wherein, however, and provided that said puncture sealing layer has a low strain storage modulus (G′) dynamic viscoelastic property (100° C., 5 percent dynamic strain and 1 hertz) in a range of from about 1 to about 100 kPa, alternately from about 10 to about 100 kPa:
   (1) 100 phr of butyl rubber as a copolymer of isobutylene and isoprene which contains about 0.05 to about 5, preferably from about 0.05 to one, percent units derived from isoprene and, correspondingly about 95 to about 99.95, preferably from 99 to about 99.95, percent derived from isobutylene, and
   (2) about 25 to about 100 phr of particulate reinforcing filler comprised from 5 to about 50 phr of carbon black, preferably rubber reinforcing carbon black, so long as the carbon black content of said puncture sealing layer is sufficient to color the said puncture sealing layer black, and:
      (a) about 20 to about 50 phr of synthetic amorphous silica, preferably precipitated silica, or
      (b) about 15 to about 30 phr synthetic amorphous silica, preferably precipitated silica, and about 5 to about 20 phr of clay, preferably kaolin clay, or
      (c) about 15 to about 30 phr synthetic amorphous silica, preferably precipitated silica, and about 5 to about 20 phr of calcium carbonate, or
      (d) about 15 to about 30 phr synthetic amorphous silica, preferably precipitated silica, about 5 to about 15 phr of clay, preferably kaolin clay, and about 5 to about 15 phr of calcium carbonate, and;
   (3) optionally from zero to 6, alternately about 0.5 to about 5, phr of short organic fibers;
   (4) optionally a polyethylene glycol having a number average molecular weight in a range of from about 2,000 to about 15,000, alternately from about 2,000 to about 10,000; and
   (5) from zero to about 20, alternately about 4 to about 15, phr of rubber processing oil, preferably a rubber processing oil having a maximum aromatic content of about 15 weight percent, and preferably a naphthenic content in a range of from about 35 to about 45 weight percent and preferably a paraffinic content in a range of about 45 to about 55 weight percent, and
   (6) a free radical generating organoperoxide;
wherein said organoperoxide is blended with said butyl rubber based rubber composition subsequent to the addition of said synthetic amorphous silica, clay and calcium carbonate and said optional polyethylene glycol;
(B) vulcanizing said tire assembly in a suitable mold at a temperature in a range of from about 130° C. to about 175° C. for a sufficient period of time to partially depolymerize said butyl rubber and thereby form a built-in sealant layer.

Alternately, in such process, the said particulate reinforcing filler may be comprised of, in addition to said carbon black:
(A) about 20 to about 50 phr of synthetic amorphous silica having a BET surface area in a range of from about 50 to about 70 m2/g, or
(B) about 12 to about 30 phr of synthetic amorphous silica having a BET surface area in a range of from about 110 to about 200 m2/g, or
(C) about 15 to about 30 phr synthetic amorphous silica having a BET surface area in a range of from about 50 to about 70 m²/g and about 5 to about 20 phr of clay, or
(D) about 5 to about 25 phr synthetic amorphous silica having a BET surface area in a range of from about 110 to about 200 m²/g and about 5 to about 20 phr of clay, or
(E) about 15 to about 30 phr synthetic amorphous silica having a BET surface area in a range of from about 50 to about 70 m²/g and about 5 to about 20 phr of calcium carbonate, or
(F) about 5 to about 25 phr synthetic amorphous silica having a BET surface area in a range of from about 110 to about 200 m²/g and about 5 to about 20 phr of calcium carbonate, or
(G) about 15 to about 30 phr synthetic amorphous silica having a BET surface area in a range of from about 50 to about 70 m²/g, about 5 to about 15 phr of clay and about 5 to about 15 phr of calcium carbonate, or
(H) about 5 to about 25 phr synthetic amorphous silica having a BET surface area in a range of from about 110 to about 200 m²/g, about 5 to about 15 phr of clay and about 5 to about 15 phr of calcium carbonate.

In practice, it is conventionally preferred that the butyl rubber and silica, and said clay and calcium carbonate where used, are blended in at least one sequential preparatory, or non-productive, mixing stage in the absence of the organoperoxide (together with at least one of the additional ingredients) followed by a final, or productive, mixing stage in which the organoperoxide (and possibly one or more of the additional ingredients) is added.

Conventionally, the non-productive mixing stage(s) may be conducted, for example, by mixing the ingredients to a temperature in a range of from about 110 to about 150° C. and the subsequent productive mixing stage may be conducted, for example, by mixing the ingredients to a temperature in a range of from about 85 to about 100° C.

A significant aspect of this invention is the at least partial depolymerization of the butyl rubber layer built into the tire (between the tire innerliner and tire carcass) during the vulcanization of the tire itself in a suitable mold at an elevated temperature via an organoperoxide in the presence of amorphous (synthetic) silica and carbon black which may optionally include clay and/or calcium carbonate to create the built-in black colored puncture sealant layer.

This is considered herein to be significant because said butyl rubber sealant precursor composition is conveniently processable as a rubber composition which can be suitably built as a rubber layer into a tire.

In practice, upon vulcanization of the tire assembly under conditions of elevated temperature, a major portion of the uncured butyl rubber composition is considered herein to be depolymerized in the presence of the organoperoxide compound to form a tacky material.

In practice, said tire innerliner halobutyl rubber-based layer is typically a sulfur curative-containing halobutyl rubber composition of a halobutyl rubber such as for example chlorobutyl rubber or bromobutyl rubber.

Such tire halobutyl rubber-based innerliner layer may also contain one or more sulfur curable diene-based elastomers such as, for example, cis 1,4-polyisoprene natural rubber, cis 1,4-polybutadiene rubber and styrene/butadiene rubber, and their mixtures, or more preferably a combination of one or more of said halobutyl rubbers and said diene based elastomers.

As the tire is vulcanized together with the butyl rubber-based rubber composition layer (the sealant layer precursor) sandwiched between the tire carcass and the tire's rubber innerliner, the butyl rubber of the butyl rubber-based composition layer which is to become the sealant layer, becomes partially depolymerized, preferably to an extent that its aforesaid resultant storage modulus (G′) physical property, at a 5 percent dynamic strain at 100° C. and 1 hertz, in a range of from about 1 to about 100, alternately from about 10 to about 100 kPa, alternately in a range of from about 10 to about 40 kPa.

In effect, the butyl rubber in the butyl rubber based composition sealant layer is depolymerized to a low viscosity to form a tacky material which has puncture sealing properties. Thus, the butyl rubber composition sealant precursor layer is transformed into a puncture sealant layer during the curing of the tire. This at least partial depolymerization of the butyl rubber composition layer is effectuated by the presence of the one or more free radical-generating organoperoxides contained in the butyl rubber sealant precursor composition.

In practice, the butyl rubber composition as the sealant precursor contains a sufficient amount of the free radical-generating organoperoxide to cause the butyl rubber to partially depolymerize, which may be, for example, in a range of from about 0.5 to about 15 phr of the active organoperoxide depending somewhat upon the time and temperature of the tire curing operation and the degree of depolymerization desired. The various components of the sealant layer can be mixed together using convenient rubber mixing equipment, particularly an internal rubber mixer. The rubber composition used in the sealant precursor layer typically has sufficient viscosity and unvulcanized tack to enable its incorporation into an unvulcanized tire without significantly departing from conventional tire building techniques.

In an exemplary method of this invention, the butyl rubber-based sealant precursor composition can be formed into a rubber strip by using conventional equipment such as a calender, extruder, or any combination thereof, and the rubber strip assembled into the tire. In building the tires of this invention a rubber innerliner of a butyl rubber based (e.g. bromobutyl rubber) rubber composition is first applied to a building drum and then the strip of butyl rubber based sealant precursor layer is applied to the layer of innerliner and thereafter the remainder of various carcass plies and layers of the tire assembly. The butyl rubber based sealant precursor layer is thereby assembled into the unvulcanized tire assembly of components between an innerliner layer and tire carcass.

The built-in sealant layer may, for example, be positioned between a tire innerliner rubber layer and tire carcass or between two tire innerliner rubber layers wherein said sealant layer may:
(A) extend from one shoulder of the tire to the other through the crown region of the tire;
(B) be positioned in at least one tire shoulder area region and extend into at least a portion of the adjoining tire sidewall portion of the tire, or
(C) extend from sidewall-to-sidewall through the tire crown region.

The thickness of the sealant composition layer can vary greatly in an unvulcanized puncture sealant containing tire. Generally, the thickness of the sealant composition layer may range from about 0.13 cm (0.05 inches) to about 1.9 cm (0.75 inches). In passenger tires it is normally desired for the sealant composition layer to have a thickness of about 0.32 cm (0.125 inches) whereas for truck tires, a thickness of about 0.76 cm (0.3 inches) or greater might be desired.

After the unvulcanized pneumatic rubber tires of this invention are assembled they are vulcanized using a normal tire cure cycle. The tires of this invention can be cured over a wide temperature range. For example, passenger tires might be cured at a temperature ranging from about 130° C. to about 170° C. and truck tires might be cured at a temperature ranging from about 130° C. to about 170° C. Thus, a cure temperature may range, for example, from about 130° C. to about 170° C. and for a period of time (e.g. from about 10 to about 45 minutes or more depending somewhat upon the size of the tire and the degree of desired depolymerization of the butyl rubber as well as the thickness of the sealant layer itself) and sufficient to at least partially depolymerize said sealant precursor layer to the aforesaid storage modulus (G′) physical property. In practice, a period of time used to vulcanize the tires, in a suitable mold, may therefore, for example, have a duration of about 10 to 14 minutes for a passenger tire and for about 25 to about 55 minutes for a truck tire.

Accordingly, in one aspect of the invention, a self-sealing pneumatic rubber tire of this invention is envisioned wherein the tire has sidewalls, a supporting carcass, inextensible beads, an innerliner (air barrier layer), a sealant layer, and an outer circumferential tread (tread portion). The individual sidewalls extend radially inward from the axial outer edges of the tread portion to join the respective inextensible beads. The supporting carcass acts as a supporting structure for the tread portion and sidewalls. The sealant layer is disposed between said supporting carcass and said innerliner. The outer circumferential tread is adapted to be ground contacting when the tire is in use.

The following examples are included to further illustrate the method of manufacturing the self-sealing pneumatic rubber tires of this invention. These examples are intended to be representative of the present invention and are not to be regarded as limiting the scope of the invention or the manner in which it can be practiced. Unless specifically indicated otherwise, parts and percentages are given by weight.

While certain representative embodiments and details have been shown for the purpose of illustrating the invention, it will be apparent to those skilled in this art that various changes and modifications may be made therein without departing from the spirit or scope of the invention.

1. A pneumatic rubber tire having a built-in black colored puncture sealing layer, wherein said puncture sealing layer contains an at least partially organoperoxide-depolymerized butyl rubber-based sealant layer positioned between a halobutyl rubber tire innerliner and a conjugated diene-based tire carcass, and wherein said puncture sealing layer is comprised of, based upon parts by weight per 100 parts by weight of said partially depolymerized butyl rubber, and
wherein, however, and provided that said puncture sealing layer has a low strain storage modulus (G′) dynamic viscoelastic property (100° C., 5 percent dynamic strain and 1 hertz) in a range of from about 1 to about 100 kPa;
(A) a partially organoperoxide-depolymerized butyl rubber as a copolymer of isobutylene and isoprene,
wherein said butyl rubber, prior to such depolymerization, is comprised of about 0.5 to about 5 percent units derived from isoprene, and correspondingly from about 95 to about 99.5 weight percent units derived from isobutylene;
(B) about 24 to about 100 phr of particulate reinforcing filler comprised of about 4 to about 50 phr of carbon black, so long as the carbon black content of said puncture sealing layer is sufficient to color the said puncture sealing layer black, and:
(1) about 20 to about 50 phr of synthetic amorphous silica, or
(2) about 15 to about 30 phr synthetic amorphous silica, preferably precipitated silica, and about 5 to about 20 phr of clay, or
(3) about 15 to about 30 phr synthetic amorphous silica and about 5 to about 20 phr of calcium carbonate, or
(4) about 15 to about 30 phr synthetic amorphous silica, about 5 to about 15 phr of clay and about 5 to about 15 phr of calcium carbonate;
(C) from zero to 6 phr of short organic fibers;
(D) from zero to about 20 phr of rubber processing oil;
wherein said synthetic amorphous silica, and clay and calcium carbonate where used, is treated by treatment prior to addition of said organoperoxide either in situ within the rubber composition or by pre-treatment of said silica prior to its addition to the rubber composition to inhibit adsorption or absorption of said organoperoxide on the surface of said silica.

2. The tire of claim 1 wherein said silica is a precipitated silica and said silica is pretreated to inhibit adsorption of absorption of said organoperoxide on the surface of said silica with:
(A) a polyethylene glycol having a weight average molecular weight in a range of from about 2,000 to about 15,000, alternately about 2,000 to about 10,000, or
(B) an alkoxysilane or
(C) a coupling agent selected from a bis(3-trialkoxysilylalkyl) polysulfide or organomercaptoalkoxysilane, or
(D) a combination of alkylsilane, particularly an alkoxysilane, and bis(3-trialkoxysilylalkyl) polysulfide or organomercaptoalkoxysilane.

3. The tire of claim 1 wherein said butyl rubber of said sealant precursor is comprised of a plurality of butyl rubbers comprised of a first butyl rubber having a Mooney (ML1+4), 125° C., viscosity in a range of from about 35 to about 60 and at least one additional butyl rubber having a Mooney (M1+4), 125° C., in a range of from about 25 to about 45, wherein the Mooney viscosity of said first butyl rubber is at least 10 Mooney viscosity units higher than the Mooney viscosity of said additional butyl rubber.

4. The tire of claim 1 wherein said butyl rubber, prior to such depolymerization, is comprised of about 0.5 to about 1 percent units derived from isoprene, and correspondingly from about 99 to about 99.5 weight percent units derived from isobutylene.

5. The tire of claim 1 wherein said silica of said reinforcing filler is a precipitated silica and said reinforcing filler contains about 20 to about 50 phr of said precipitated silica.

6. The tire of claim 1 wherein said silica of said reinforcing filler is a precipitated silica and said reinforcing filler contains about 15 to about 30 phr of said precipitated silica and about 5 to about 20 phr of clay.

7. The tire of claim 1 wherein said silica of said reinforcing filler is precipitated silica and said reinforcing filler contains about 15 to about 30 phr of said precipitated silica and about 5 to about 20 phr of calcium carbonate.

8. The tire of claim 1 wherein said silica of said reinforcing filler is a precipitated silica and said reinforcing filler contains about 15 to about 30 phr of said precipitated silica, about 5 to about 15 phr of clay and about 5 to about 15 phr of calcium carbonate.

9. A method of preparing a pneumatic tire having a puncture sealing ability comprised of an assembly of components comprised of an outer circumferential sulfur curable rubber tread, at least one rubber carcass ply supporting said tread and an inner halobutyl rubber-based tire innerliner layer, wherein said method comprises:
(A) positioning a layer of an uncured butyl rubber-based rubber composition, exclusive of sulfur curative, as a sealant layer precursor between said innerliner and rubber carcass, wherein said sealant precursor butyl rubber-based composition is prepared by blending, based upon parts by weight per 100 parts of butyl rubber (phr):
wherein, however, and provided that said puncture sealing layer has a low strain storage modulus (G′) dynamic viscoelastic property (100° C., 5 percent dynamic strain and 1 hertz) in a range of from about 1 to about 100 kPa;
(1) 100 phr of butyl rubber as a copolymer of isobutylene and isoprene which contains about 0.05 to about 5 percent units derived from isoprene and, correspondingly about 95 to about 99.95 percent derived from isobutylene, and
(2) about 24 to about 100 phr of particulate filler comprised of about 4 to about 50 phr of carbon black, so long as the carbon black content of said puncture sealing layer is sufficient to color the said puncture sealing layer black, and:
(a) about 20 to about 50 phr of synthetic amorphous silica, or
(b) about 15 to about 30 phr synthetic amorphous silica and about 5 to about 20 phr of clay, or
(c) about 15 to about 30 phr synthetic amorphous silica and about 5 to about 20 phr of calcium carbonate, or
(d) about 15 to about 30 phr synthetic amorphous silica, about 5 to about 15 phr of clay and about 5 to about 15 phr of calcium carbonate, and;
(3) optionally from zero to 6 phr of short organic fibers;
(4) optionally a polyethylene glycol having a number average molecular weight in a range of from about 2,000 to about 15,000;
(5) from zero to about 20 phr of rubber processing oil; and
(6) a free radical generating organoperoxide;
wherein said organoperoxide is blended with said butyl rubber based rubber composition subsequent to the addition of said synthetic amorphous silica, clay and calcium carbonate, and optionally polyethylene glycol;
(B) vulcanizing said tire assembly in a suitable mold at a temperature in a range of from about 130° C. to about 175° C. for a sufficient period of time to partially depolymerize said butyl rubber and thereby form a built-in sealant layer;
wherein said synthetic amorphous silica, and clay and calcium carbonate where used, is treated by treatment prior to addition of said organoperoxide either in situ within the rubber composition or by pre-treatment of the silica prior to its addition to the rubber composition with:
(C) a polyethylene glycol having a weight average molecular weight in a range of from about 2,000 to about 15,000, alternately about 2,000 to about 10,000, or
(D) an alkoxysilane or
(E) a coupling agent selected from a bis(3-trialkoxysilylalkyl) polysulfide or organomercaptoalkoxysilane, or
(F) a combination of an alkoxysilane, and bis(3-trialkoxysilylalkyl) polysulfide or organomercaptoalkoxysilane.

10. The tire of claim 1 wherein said silica is a precipitated silica.

11. The tire of claim 1 wherein said organoperoxide depolymerized butyl rubber is depolymerized with an organoperoxide selected from n-butyl 4,4-di-(tert-butylperoxy) valerate, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy) hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy) hexane.

12. The tire of claim 11 wherein said organoperoxide is n-butyl 4,4-di-(tert-butylperoxy) valerate as a composite thereof on a mineral carrier.

13. The tire of claim 1 wherein said polyethylene glycol has an average (weight average) molecular weight in a range of from about 2,000 to about 15,000.

14. The tire of claim 1 wherein said coupling agent is a bis(3-triethoxysilylpropyl) polysulfide which contains an average of from 2 to about 4 connecting sulfur atoms in its polysulfidic bridge.

15. The tire of claim 1 wherein said alkoxysilane is of the general formula (I):
(RO)₃—Si—R¹ (I)
where R is selected from methyl and ethyl radicals, preferably ethyl radicals, and R¹ is a saturated alkyl radical having from 2 through 6 carbon atoms.

16. The tire of claim 1 wherein said alkoxysilane is selected from trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

17. The tire of claim 1 wherein said coupling agent is an organomercaptoalkoxysilane of the general formula (11):
(X)ₙ (R²O)₃₋ₙ—Si—R³—SH (II)
wherein X is a radical selected from chlorine, bromine, and alkyl radicals having from one to 16 carbon atoms; wherein R² is an alkyl radical selected from methylene and ethylene radicals, R³ is an alkylene radical having from one to 16 carbon atoms and n is a value from zero to 3.

18. The tire of claim 1 wherein said coupling agent is an alkoxyorganomercaptosilane selected from triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

19. The tire of claim 1 wherein said sealant composition contains from about 0.5 to about 5 phr of short fibers selected from cotton fibers and from synthetic fibers selected from rayon, aramid, nylon and polyester fibers, and their mixtures.

20. The tire of claim 1 wherein said sealant layer is positioned between a carbon black reinforced tire innerliner rubber layer and tire carcass or between two tire innerliner rubber layers and, wherein said sealant layer:
(A) extends from one shoulder of the tire to the other through the crown region of the tire;
(B) is positioned in at least one tire shoulder area region and extends into at least a portion of the adjoining tire sidewall portion of the tire, or
(C) extends from sidewall-to-sidewall through the tire crown region.

21. The tire of claim 1 wherein said black colored built-in sealant layer is positioned between a carbon black reinforced innerliner and tire carcass or between two carbon black reinforced tire innerliners, and wherein said tire has a carbon black reinforced tire tread and sidewall.

22. The tire of claim 1 wherein said precipitated silica has a BET (nitrogen) surface area in a range of from about 50 to about 70 m²/g.

23. The tire of claim 1 wherein said precipitated silica has a BET (nitrogen) surface area in a range of from about 110 to about 200 m²/g.

24. A pneumatic rubber tire having a built-in black colored puncture sealing layer, wherein said puncture sealing layer contains an at least partially organoperoxide-depolymerized butyl rubber-based sealant layer positioned between a halobutyl rubber tire innerliner and a conjugated diene-based tire carcass, and wherein said puncture sealing layer is comprised of, based upon parts (phr) by weight per 100 parts by weight of said partially depolymerized butyl rubber:
wherein, however, and provided that said puncture sealing layer has a low strain storage modulus (G′) dynamic viscoelastic property (100° C., 5 percent dynamic strain and 1 hertz) in a range of from about 1 to about 100 kPa;
(A) a partially organoperoxide-depolymerized butyl rubber as a copolymer of isobutylene and isoprene,
wherein said butyl rubber, prior to such depolymerization, is comprised of about 0.5 to about 5 percent units derived from isoprene, and correspondingly from about 95 to about 99.5 weight percent units derived from isobutylene;
(B) about 24 to about 100 phr of particulate filler comprised of about 4 to about 50 phr of carbon black, so long as the carbon black content of said puncture sealing layer is sufficient to color the said puncture sealing layer black, and:
(1) about 20 to about 50 phr of precipitated silica having a BET surface area in a range of from about 50 to about 70 m²/g, or
(2) about 12 to about 30 phr of precipitated silica having a BET surface area in a range of from about 110 to about 200 m²/g, or
(3) about 15 to about 30 phr precipitated silica having a BET surface area in a range of from about 50 to about 70 m²/g and about 5 to about 20 phr of clay, or
(4) about 5 to about 25 phr precipitated silica having a BET surface area in a range of from about 110 to about 200 m²/g and about 5 to about 20 phr of clay, or
(5) about 15 to about 30 phr precipitated silica having a BET surface area in a range of from about 50 to about 70 m²/g and about 5 to about 20 phr of calcium carbonate, or
(6) about 5 to about 25 phr precipitated silica having a BET surface area in a range of from about 110 to about 200 m²/g and about 5 to about 20 phr of calcium carbonate, or
(7) about 15 to about 30 phr precipitated silica having a BET surface area in a range of from about 50 to about 70 m²/g, about 5 to about 15 phr of clay and about 5 to about 15 phr of calcium carbonate, or
(8) about 5 to about 25 phr precipitated silica having a BET surface area in a range of from about 110 to about 200 m²/g, about 5 to about 15 phr of clay and about 5 to about 15 phr of calcium carbonate;
(C) from zero to 6 phr of short organic fibers;
(D) from zero to about 20 phr of rubber processing oil;
wherein said precipitated silica, and clay and calcium carbonate where used, is treated by treatment prior to addition of said organoperoxide either in situ within the rubber composition or by pre-treatment of said silica prior to its addition to the rubber composition with:
(E) a polyethylene glycol having a weight average molecular weight in a range of from about 2,000 to about 15,000, alternately about 2,000 to about 10,000, or
(F) an alkoxysilane or
(G) a coupling agent selected from a bis(3-trialkoxysilylalkyl) polysulfide or organomercaptoalkoxysilane, or
(H) a combination of an alkoxysilane, and bis(3-trialkoxysilylalkyl) polysulfide or organomercaptoalkoxysilane.

25. The tire of claim 24 wherein said organoperoxide depolymerized butyl rubber is depolymerized with an organoperoxide selected from n-butyl 4,4-di-(tert-butylperoxy) valerate, 2,5-bis(t-butyl peroxy)-2,5-dimethyl hexane; 1,1-di-t-butyl peroxi-3,3,5-trimethyl cyclohexane; 2,5-dimethyl-2,5-di(t-butyl peroxy) hexyne-3; p-chlorobenzyl peroxide; 2,4-dichlorobenzyl peroxide; 2,2-bis-(t-butyl peroxi)-butane; di-t-butyl peroxide; benzyl peroxide; 2,5-bis(t-butyl peroxy)-2,5-dimethyl hexane, dicumyl peroxide; and 2,5-dimethyl-2,5-di(t-butyl peroxy) hexane.

26. The tire of claim 24 wherein said polyethylene glycol has an average (weight average) molecular weight in a range of from about 2,000 to about 15,000.

27. The tire of claim 24 wherein said coupling agent is a bis(3-triethoxysilylpropyl) polysulfide which contains an average of from 2 to about 4 connecting sulfur atoms in its polysulfidic bridge.

28. The tire of claim 24 wherein said alkoxysilane is of the general formula (1):
(RO)₃—Si—R¹ (I)
where R is selected from methyl and ethyl radicals and R¹ is a saturated alkyl radical having from 2 through 6 carbon atoms.

29. The tire of claim 24 wherein said alkoxysilane is selected from trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

30. The tire of claim 24 wherein said coupling agent is an organomercaptoalkoxysilane of the general formula (II):
(X)ₙ (R²O)₃₋ₙ—Si—R³—SH (II)
wherein X is a radical selected from chlorine, bromine, and alkyl radicals having from one to 16 carbon atoms; wherein R² is an alkyl radical selected from methylene and ethylene radicals, R³ is an alkylene radical having from one to 16 carbon atoms and n is a value from zero to 3.

31. The tire of claim 24 wherein said coupling agent is an alkoxyorganomercaptosilane selected from triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

32. The tire of claim 24 wherein said sealant composition contains from about 0.5 to about 5 phr of short fibers selected from cotton fibers and from synthetic fibers selected from rayon, aramid, nylon and polyester fibers, and their mixtures.

33. The tire of claim 24 wherein said sealant layer is positioned between a carbon black reinforced tire innerliner rubber layer and tire carcass or between two tire innerliner rubber layers and, wherein said sealant layer:
(A) extends from one shoulder of the tire to the other through the crown region of the tire;
(B) is positioned in at least one tire shoulder area region and extends into at least a portion of the adjoining tire sidewall portion of the tire, or
(C) extends from sidewall-to-sidewall through the tire crown region.

34. The tire of claim 24 wherein said black colored built-in sealant layer is positioned between a carbon black reinforced innerliner and tire carcass or between two carbon black reinforced tire innerliners, and wherein said tire has a carbon black reinforced tire tread and sidewall.

35. The tire of claim 1 wherein the said silica containing built-in black colored sealant layer with its said storage modulus (G′) characterization is designed to seal against a puncturing object which extends through the tire casing to said built-in sealant layer, and/or a puncture extending through the tire casing to said built-in sealant layer caused by said puncturing object, by the said sealant layer actively physically pressing against said puncturing object and/or said puncture as a response to a pressure differential between the air contained in the tire cavity and external atmospheric pressure.

36. The tire of claim 1 wherein said sealant precursor layer, prior to the said depolymerization of the butyl rubber contained therein, is of a rubber composition having low strain storage modulus (G′) at 100° C., 5 percent dynamic strain and 1 hertz, in a range of from about 170 to about 350 kPa.
